(19) United States
(12) Patent Application Publication
(10) Pub. No.: US 2015/0217207 A1
(43) Pub. Date: Aug. 6, 2015

(54) SYSTEM FOR VISUAL EXPRESSION OF ACOUSTIC INFORMATION

(71) Applicant: MICKAUS KURYBOS STUDIJA, MB, Vilnius (LT)

(72) Inventors: Virginijus Mickus, Vilnius (LT); Ruta Mickiene, Vilnius (LT)

(73) Assignee: MICKAUS KURYBOS STUDIJA, MB, Vilnius (LT)

(21) Appl. No.: 14/426,345

(22) PCT Filed: Dec. 17, 2012
(86) PCT No.: PCT/IB2012/057375

§ 371 Date: Mar. 5, 2015

(30) Foreign Application Priority Data
Oct. 22, 2012 (LT) 2012-097

(51) Int. Cl. A63J 5/10; G01H 17/00

(52) U.S. Cl. CPC A63J 5/10; G01H 17/00

(57) ABSTRACT

This invention provides a solution for an artistic visualization of acoustic waves, employing an acoustic imaging system, which comprises a sound receiving device, an information processing device, an amplifier, a vibrational device, a container with a liquid or friable medium and an imaging device. Sound receiving device either encodes the variable acoustic information to a digital signal and transfers it to the information processing device or translates it to an analog signal and transfers it through an analog line. The information processing device is arranged to separate input acoustic information into phonetic elements which are later visualized. Said sound receiving and information processing devices are adapted to communicate through mobile communication or internet networks or through a simple wire connection. Digital or analog signal is sent to the vibrational device which oscillates upon the actuation of the input signal and produces acoustic waves as an output. Acoustic waves induce the formation of the vibratory pattern on the surface of the liquid or friable medium. The vibrational pattern is then captured by the imaging device and shown live on the display, broadcasted or multi-layer pictures are created and printed or stored in USB, CD or another data storage unit, or transferred to the user by means of data communication networks. Variable acoustic information is preferably a verbal phrase and phonetic elements are words or syllables.

### FIELD OF INVENTION

The invention relates to methods of imaging. More particularly it relates to artistic imaging of acoustic waves by means of transferring vibrations to some liquid or friable medium and visualizing them.

### BACKGROUND OF INVENTION

There is a variety of methods used to visualize acoustic waves. These methods range from simple audio analyzers, to complex methods, which involve plurality of effects, for example acoustic holography.

Most of the acoustic imaging devices are functioning by means of receiving the sound signals, interpreting and processing them using information processing devices, such as personal computers, smart phones and similar. Processed data is displayed in the screen, connected to the information processing device, or printed. Previous patented inventions are known, describing methods of acoustic imaging.

A British patent No. GB1443443, published on 1973 Apr. 2, describes an acoustic imaging method, based on acoustic holography. Vibration sensors in an array are selectively energized by acoustic waves to form a vibratory pattern characteristic of the structure of an object being imaged, and the pattern is illuminated with coherent light in a holographic or interferometric imaging system to form a corresponding pattern of “live” or “time-averaged” interference fringes characteristic of the structure of the object. The array comprises a metal or ceramic plate diced on both sides to form acoustically-isolated half-wave resonators or quarter-wave resonators. The vibrational pattern set up on the array is made visible as “live fringes” by directing light from laser directly, and via reflection from the array's lower surface, on to a previously-recorded hologram of the array when stationary. The fringes are viewed through the hologram.

Another British patent No. GB1460056, published in 1976 Dec. 31, discloses a method for detecting acoustic images, involving image, formed on polymer, scanning with the electron beam. An acoustic image produced by, e.g. foetus is focused by acoustic lens, through acoustic medium on to an imaging device, which comprises a thin foil of polymer having remanent electrical polarization mounted on a pressure resistant polymer face plate of, e.g. polystyrene or polyurethane. The image so formed is scanned by an electron beam in electron tube 12, and the resulting image displayed by, e.g. video recorder, T.V. monitor.

Prior art inventions describe solutions, which are complex and more applicable in science or domestic needs, but feature quite low level of visual attraction, thus can not be used for creation of gifts or interior decorations, i.e. do not provide means for expressing acoustic information as some kind of art.

### SUMMARY

An object the present invention is to provide an artistic acoustic imaging system so as to expand the acoustic imaging market and to alleviate the complexity problem mentioned above. In other words, the invention aims at providing a system, which comprises of a sound receiving device, e.g. microphone, vibrational device, e.g. speaker, transferring vibrations to a liquid or friable medium. Said sound receiving and vibrational devices are connected preferably through at least an information processing device, which is used for recording and reprocessing of the recorded sound signal. Further, an image acquisition device is used to capture views of wave and light pattern induced in the said media. The possibility of using conventional imaging devices, comprising user friendly control means, is considered as an advantage, provided by this invention.

Said sound receiving part of the acoustic imaging system can be any device, that transfers the audio signal to the digital or analog signal. A digital signal is adapted to be transferred and processed in an information processing device, such as personal computer, notebook, tablet computer or similar, which include the data processing software installed. Transferring of the signal is achieved by employing any conventional digital communication method, e.g. cable internet connection, wireless, bluetooth or similar. Whereas analog signal, i.e. electrical pulses, are adapted to be transferred directly to the amplifier, eliminating the need of the information processing device.

Said vibrational part of the acoustic imaging system can be any device, that receives the signal and converts it back to the acoustic signal, which is emitted from the vibrational device in order to induce vibrations in the liquid or friable medium, e.g. water, sand, etc.

Said imaging part of the system can be any device, that records the visual information, e.g. cameras, video recorders, etc. The device should be adapted to connect to the information processing device in order to show the recorded data in a display. Connection to the information processing device could be established using wireless communication method, USB or similar connection. Imaging device should have a proper illumination system in order to record the highest quality and most appealing visual information.

### DESCRIPTION OF DRAWINGS

In order to understand the invention better, and appreciate its practical applications, the following pictures are provided and referenced hereafter. Figures are given as examples only and in no way limit the scope of the invention.

FIG. 1. illustrates the most preferred embodiment of the present invention, where the sound receiver (1) transfers the audio signal to the information processing device (3) through the mobile communication network/internet (2).

FIG. 2. illustrates an another embodiment of the acoustic imaging system, where a direct connection between a sound receiving device (1) and information processing device (3) is used.

FIG. 3. illustrates an another embodiment of the acoustic imaging system, where a recorded acoustic information is transferred directly to an amplifier (9).

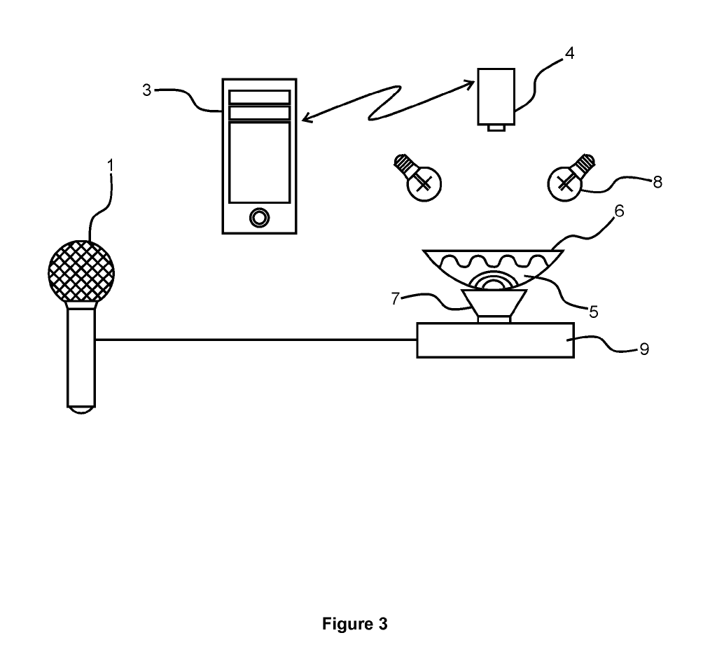

### DETAILED DESCRIPTION OF PREFERRED EMBODIMENTS

The most preferred embodiment of the present invention is an acoustic imaging system, comprising at least a sound system, container (6) with a liquid or friable medium (5) and an imaging device (4). Said sound system is comprised of a sound receiving device (1), optionally an information processing device (3), an amplifier (9) and a vibrational device (7). Said sound system can incorporate more elements, such as a few sound receiving or vibrational units.

Sound receiving device (1) in this context is any device that is capable of receiving acoustic waves and encoding them to the digital signal or transmitting it as an analog signal.

In the most preferred embodiment, encoded signal is transferred to the information processing device (3), which is a personal computer, but can be any information processing device, such as notebook, tablet computer, smart phone, etc.

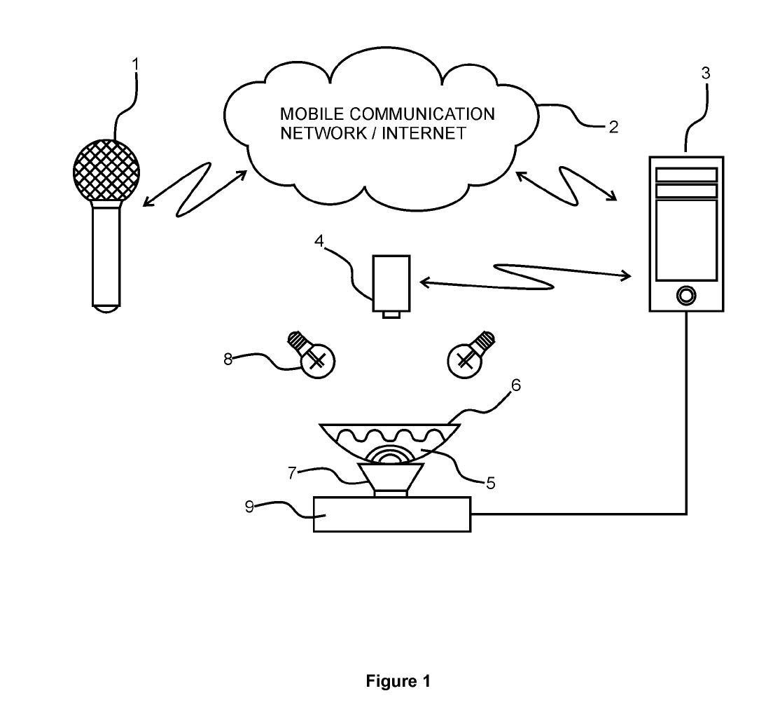

In the most preferred embodiment, encoded audio signal is sent to the information processing device by means of data communication network (2). Such network enables multiple remote users of sending the audio signal to the information processing device. As shown in FIG. 1, data communication network comprises two types of telecommunication networks, the first one being the packet—switched network, which allows users to connect through an optical fiber, LAN, WiFi or similar standard method or protocol, whereas the second type is a mobile communication network, which supports standard protocols, such as GPRS, EDGE, GSM, WCDMA, 3G, 4G, HSDPA, etc. It should be appreciated that present invention is not limited to the specific type of data communication network and the person, skilled in the art, can apply such knowledge creatively for proper realization of this invention.

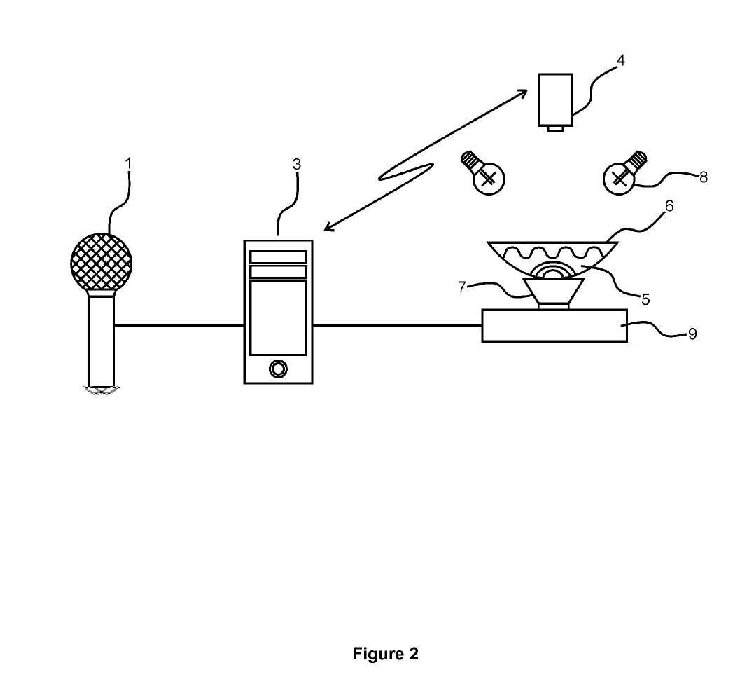

Yet in another preferred embodiment, encoded audio signal is sent to the information processing device (3) by means of a electrical wire connection as shown in FIG. 2. This embodiment is limited to the length of the wire, but provides high quality and high speed information transfer.

Yet in another preferred embodiment, acoustic signal, captured by sound receiving device (1), is translated to electrical pulses, i.e. analog signal. Analog signal is transmitted through the analog line directly to the amplifier (9), where it is amplified and transferred to the vibrational device (7). This embodiment eliminates the need of employing information processing device (3) from an acoustic signal chain (1, 9, 7).

In the most preferred embodiment, vibrational device (7) is any device, which receives an input digital or analog signal and produces acoustic waves as an output. Vibrational device (7) employs a membrane which oscillates upon the actuation of the input signal. Oscillations of matter result in production of acoustic waves. Vibrational device (7) is arranged directly under the container (6), filled with liquid or friable medium (5), to ensure the most effective induction of vibrations in the said media. The arrangement of the vibrational device should not be considered as limiting as far as vibrational device is capable of inducing vibrations in the said media. Preferably, the vibrational device (7) is a speaker.

Yet in another preferred embodiment, vibrational device (7) is a device, which employs eccentric rotating mass vibration motor, which produces vibrations upon the actuation of electrical signal. Eccentric rotating mass vibration motor is a DC motor with a non-symmetric mass attached to the shaft. When the motor rotates, a centripetal force is created, but because of the asymmetric mass a net centrifugal force is also created and both of these forces cause the displacement of the motor. Supposing that the motor employs a high number of revolutions per minute, repetitive displacement of the motor is perceived as vibrations.

Yet in another preferred embodiment, vibrational device is a device, which employs a piezoelectric medium in order to produce vibrations. Piezoelectric medium is based on piezoelectric effect, when the piezoelectric medium changes its dimensions upon application of the electric field. Supposing that the electric field is applied at high frequency, changes of the piezoelectric medium dimensions occur at the same high frequency, resulting in vibrations of the piezoelectric medium, thus acoustic waves are generated.

In the most preferred embodiment, liquid or friable medium (5) is considered as a state of the medium with an constant volume but no fixed shape. Incident acoustic waves transfer energy to the liquid or friable medium. Certain pattern is established depending on dimensions of the container, frequency of incident acoustic waves and properties of the medium. Depending of the vibration frequency, properties of the medium and dimensions of the container, different patterns are created. Upon illumination of the pattern, reflections, refractions and scattering occur, thus forming a complex image which is captured by the imaging device (4). In the most preferred embodiment the liquid medium is water, but it should not be considered as limiting and the person, skilled in the art, could apply such knowledge to realize some other embodiments of this invention. Pattern structure also depends on the shape of the container, but the shape should not be considered as limiting as far as container is able to hold the liquid medium.

In the most preferred embodiment, imaging device (4) is any device that has a user friendly control interface and is capable of recording the visual information and transferring it to the information processing device (3). In this case, imaging device could be photo/video camera. Vibrations, induced in the liquid or friable medium, are recorded, employing said imaging device. In the most preferred embodiment recording can be achieved by capturing pictures of the induced vibrations. Captured pictures are processed in the information processing device (3) and the artistic image is created by layering multiple captured patterns.

Yet in another preferred embodiment, patterns are recorded by employing video camera. Recorded patterns are shown live in the computer display.

In the most preferred embodiment, variable acoustic information, expressed by the user of the imaging system is a verbal phrase, pronounced by the user, musical work, performed with a musical instrument real-time, acoustic information, produced by radio, TV, stereo system or any other device, which emits the acoustic waves. Said acoustic information is separated into the number of phonetic elements or groups thereof. Each of the said phonetic elements or groups produce a distinct vibrational pattern in the liquid or friable medium which is captured by the imaging device (4). Said pictures of the patterns are summed up by layering them by means of the information processing device (3). For example, a sentence or a greeting is pronounced by a user. Said sentence or greeting is split into phonetic elements or groups, i.e. words or syllables. Each of said elements or groups create different vibrational patterns which are captured by an imaging device (4). Captured pictures are layered by means of the information processing device (3) and printed or stored in USB, CD or similar type data storage unit, or sent to the user, employing data communication networks. This method is called parallelization of images.

Yet in another preferred embodiment, variable acoustic information is separated into number of phonetic elements, such as words or syllables. Said phonetic elements are parallelized in the information processing device (3) and emitted at once. In this embodiment usually one image is captured, which represents vibrations, induced by all phonetic elements in the liquid or friable medium. This method is called parallelization of phonetic elements.

Yet in another preferred embodiment, acoustic information, expressed by the user of the acoustic imaging system, is any acoustic information, provided not in real-time, i.e. recorded and stored in the information processing and/or storing device as a sound format data file. Said data file is transferred to the information processing device (3) of the acoustic imaging system. The system further operates according to the embodiments, described above. This embodiment eliminates the sound receiving device (1) from the acoustic imaging system.

It should be obvious, that methods for providing acoustic information or it's formats do not limit the scope of this invention and person, skilled could use such knowledge for comprehensive embodiment of the invention.

1. A system, for imaging acoustic waves, comprising at least an acoustic information source or a converter to control signal, characterized in that it further comprises:
a vibrational device (7), arranged to induce vibrations in the liquid or friable medium, based on captured acoustic waves,
a container (6), containing the liquid or friable medium (5),
an imaging device, arranged to capture or take pictures of patterns induced in the liquid or friable media.

2. The system according to claim 1, characterized in that the system further comprises information processing device (3) arranged to process said captured images or video in order to create a video output or an image output.

3. The system according to one of the claims 1 to 2, characterized in that video output is shown live in a broadcast or stored as a data file.

4. The system according to one of the claims 1 to 3, characterized in that image output files are layered in order to create a picture.

5. The system according to one of the claims 1 to 4, characterized in that the converted acoustic signal is transferred through the mobile communication or internet networks (2).

6. The system according to one of the claims 1 to 5, characterized in that said vibrational device (7) is any device, arranged to produce acoustic waves upon the actuation using a digital or an analog input signal.

7. The system according to one of the claims 1 to 6, characterized in that said sound receiving device (1) is one of a dynamic microphone, a condenser microphone, a ribbon microphone, a carbon microphone, a piezoelectric microphone, a fiber optic microphone or similar.

8. The system according to one of the claims 1 to 7, characterized in that said container (6) comprises a membrane, which oscillates upon actuation using acoustic waves and transfers vibrations to the surface of the liquid or friable medium (5).

9. A method for visualizing acoustic information, characterized in that variable acoustic information is separated into distinct phonetic elements and multiple elements are visualized using a system according to one of the claims 1 to 8.

10. The method according to claim 9, characterized in that images of vibrations are layered in the information processing device (3) in order to create a single picture, which represents whole variable acoustic information.

11. The method according to claim 9, characterized in that all phonetic elements are played-back at once and a single picture, representing whole variable acoustic information, is created,

12. The method according to one of claims 9 to 11, characterized in that said variable acoustic information is a verbal phrase and said phonetic elements are words or syllables.

13. The method according to claim 12, characterized in that said variable acoustic information is a greeting.
